(19) United States
(12) Patent Application Publication
(10) Pub. No.: US 2022/0014416 A1
(43) Pub. Date: Jan. 13, 2022

(54) CLOUD-BASED REMOTE MANAGEMENT INTERFACE

(71) Applicant: Dell Products L.P., Round Rock, TX (US)

(72) Inventors: Wenfeng LI, Shanghai (CN); Muzhar S. KHOKHAR, Shrewsbury, MA (US)

(73) Assignee: Dell Products L.P., Round Rock, TX (US)

(21) Appl. No.: 16/926,032

(22) Filed: Jul. 10, 2020

(51) Int. Cl. H04L 12/24; G06F 9/54

(52) U.S. Cl. CPC H04L 41/0273; G06F 9/543; G06F 9/547; H04L 41/04

(57) ABSTRACT

An information handling system may include at least one processor and a non-transitory memory coupled to the at least one processor. The information handling system may be configured to: provide a management portal to a user via a network, wherein the management portal is configured to provide access to management interactions for a plurality of information handling resources having different management interfaces, and wherein the management portal is configured to provide access to such different management interfaces via a single interface exposed to the user; receive a management request from a user via the management portal for management of a particular information handling resource having a particular one of the different management interfaces; and dispatch the management request to the particular information handling resource for conversion into the particular one of the different management interfaces.

### TECHNICAL FIELD

The present disclosure relates in general to information handling systems, and more particularly to the management of information handling systems such as server information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system).

Some users of information handling systems (particularly HCI systems) would prefer to transition from purely on-premises local device management to a cloud-based central management system. While some information handling systems and components thereof may implement individual application programming interfaces (APIs) such as representational state transfer (REST) APIs to achieve each specific type of remote communication, the managed device/system typically exposes various disparate interfaces to exchange content. For example, plain text files, scripts, shell commands, remote procedure calls, REST APIs, etc. may all need to be dispatched from the cloud management system and executed remotely on customer devices to manage the systems and components that have different management interfaces.

The lack of a uniform management interface built on top of a secure channel between the cloud system and customer site devices imposes significant management costs.

Accordingly, embodiments of this disclosure may provide a uniform management interface layer framework to wrap or encapsulate the various content interfaces required by individual customer devices. Such a uniform management interface may carry out various operations and/or commands to allow the central management system to talk with remote systems more easily and transparently in a consistent way.

The ability to provide a uniform management interface for performing management tasks related to disparate information handling resources may provide many benefits, as discussed in further detail below.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with the management of server information handling systems may be reduced or eliminated.

In accordance with embodiments of the present disclosure, an information handling system may include at least one processor and a non-transitory memory coupled to the at least one processor. The information handling system may be configured to: provide a management portal to a user via a network, wherein the management portal is configured to provide access to management interactions for a plurality of information handling resources having different management interfaces, and wherein the management portal is configured to provide access to such different management interfaces via a single interface exposed to the user; receive a management request from a user via the management portal for management of a particular information handling resource having a particular one of the different management interfaces; and dispatch the management request to the particular information handling resource for conversion into the particular one of the different management interfaces.

In accordance with these and other embodiments of the present disclosure, a method may include an information handling system providing a management portal to a user via a network, wherein the management portal provides access to management interactions for a plurality of information handling resources having different management interfaces, and wherein the management portal provides access to such different management interfaces via a single interface exposed to the user; the information handling system receiving a management request from a user via the management portal for management of a particular information handling resource having a particular one of the different management interfaces; and the information handling system dispatching the management request to the particular information handling resource for conversion into the particular one of the different management interfaces.

In accordance with these and other embodiments of the present disclosure, an article of manufacture may include a non-transitory, computer-readable medium having computer-executable code thereon that is executable by an information handling system for: providing a management portal to a user via a network, wherein the management portal is configured to provide access to management interactions for a plurality of information handling resources having different management interfaces, and wherein the management portal is configured to provide access to such different management interfaces via a single interface exposed to the user; receiving a management request from a user via the management portal for management of a particular information handling resource having a particular one of the different management interfaces; and dispatching the management request to the particular information handling resource for conversion into the particular one of the different management interfaces.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates a block diagram of a uniform management interface, in accordance with embodiments of the present disclosure.

### DETAILED DESCRIPTION

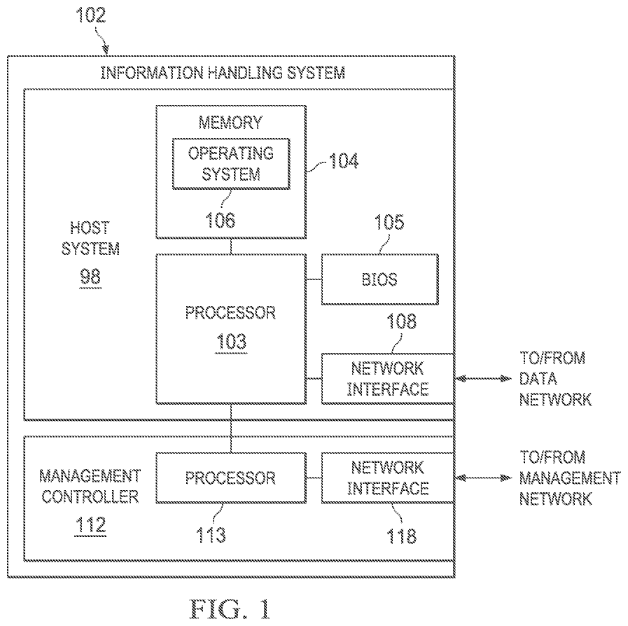

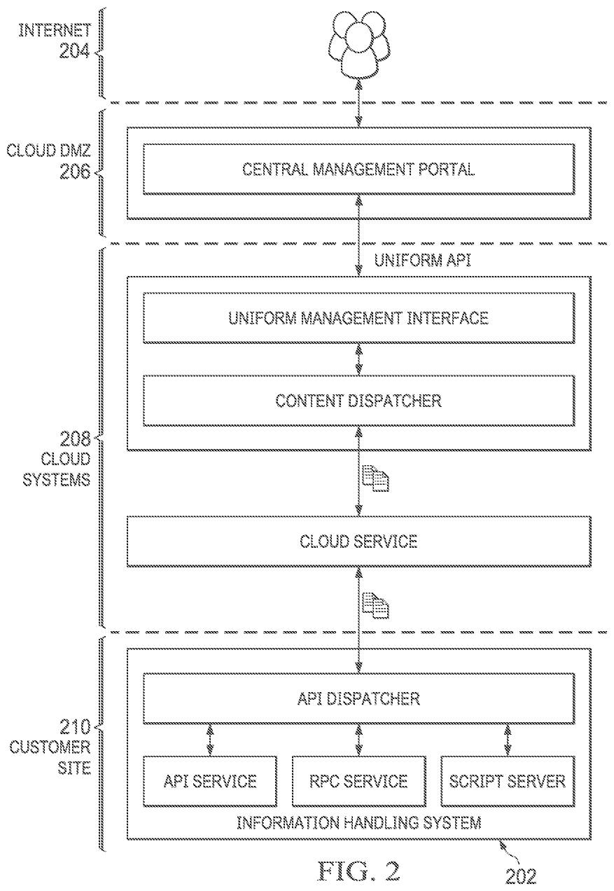

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102 (e.g., by a user operating a management console). Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure may provide a uniform management interface layer to wrap any of the various content interfaces required by information handling system 102 or information handling resources thereof.

Turning now to FIG. 2, a block diagram is shown of a uniform management interface, in accordance with some embodiments. As shown in FIG. 2, a user (e.g., an administrator) connected via internet 204 would like to perform management tasks with respect to one or more information handling systems 202 (or information handling resources thereof) disposed at customer site 210. In various embodiments, the user may be at a geographical location that is remote from customer site 210, and so the use of a cloud management interface is advantageous.

Accordingly, the user may connect to a central management portal within cloud DMZ 206 of a management system. For example, cloud DMZ 206 may provide secure access to one or more systems in cloud systems 208.

Within cloud systems 208, a uniform management interface may provide an abstracted management interface layer. In some embodiments, it may provide access to one or more uniform remote APIs to call various remote operations (e.g., remote device APIs, remote procedure calls (RPCs), scripts, shell commands, etc.).

Another component shown within cloud systems 208 is a content dispatcher, which may be configured to marshal requests from the user (e.g., serializing them as files), and dispatch the marshaled request files to systems within customer site 210.

At customer site 210, an API dispatcher may be configured to receive the remote requests from the cloud service executing within cloud systems 208, unmarshal the requests based on the underlying interface semantics of the systems being managed, and dispatch the requests to the underlying interfaces as appropriate. For example, the requests may be dispatched via an API service, an RPC service, a script service, etc. In some embodiments, the API dispatcher may also handle the results of any management interactions and return such results back to the user via cloud systems 208. In various embodiments, both synchronous and asynchronous invocations may be supported. In some embodiments, the API dispatcher may be implemented as software and/or hardware, and it may execute on a host system, a management controller, etc. For example, in some embodiments, the API dispatcher may execute on a virtual machine executing on HCI infrastructure of customer site 210.

Embodiments of this disclosure may thus provide many advantages. For example, a uniform remote management interface layer API to wrap disparate underlying interfaces has heretofore not been available. The ability to marshal requests at the cloud management system side and unmarshal them at the remote device side to conduct the underlying invocations has also not been available. Further, a cloud-based, secure transfer channel to access controlled and audited invocations has also not been available.

Although various possible advantages with respect to embodiments of this disclosure have been described, one of ordinary skill in the art with the benefit of this disclosure will understand that in any particular embodiment, not all of such advantages may be applicable. In any particular embodiment, some, all, or even none of the listed advantages may apply.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a non-transitory memory coupled to the at least one processor;
wherein the information handling system is configured to:
provide a management portal to a user via a network, wherein the management portal is configured to provide access to management interactions for a plurality of information handling resources having different management interfaces, and wherein the management portal is configured to provide access to such different management interfaces via a single interface exposed to the user;
receive a management request from a user via the management portal for management of a particular information handling resource having a particular one of the different management interfaces; and
dispatch the management request to the particular information handling resource for conversion into the particular one of the different management interfaces.

2. The information handling system of claim 1, wherein the single interface exposed to the user is a programmatic application programming interface (API).

3. The information handling system of claim 1, wherein the conversion into the particular one of the different management interfaces is carried out by an application programming interface (API) dispatcher located at a datacenter with the particular information handling resource.

4. The information handling system of claim 3, wherein the management portal is further configured to marshal the management request into a file for transmission to the datacenter.

5. The information handling system of claim 4, wherein the API dispatcher is further configured to unmarshal the management request for conversion into the particular one of the different management interfaces.

6. The information handling system of claim 1, wherein the management portal is disposed within a demilitarized zone (DMZ) of a cloud system.

7. The information handling system of claim 1, wherein the different management interfaces include a plain text file, a script, a shell command, a remote procedure call, and a representational state transfer (REST) application programming interface (API).

8. The information handling system of claim 1, wherein the information handling system comprises a hyper-converged infrastructure (HCI) system.

9. A method comprising:
an information handling system providing a management portal to a user via a network, wherein the management portal provides access to management interactions for a plurality of information handling resources having different management interfaces, and wherein the management portal provides access to such different management interfaces via a single interface exposed to the user;
the information handling system receiving a management request from a user via the management portal for management of a particular information handling resource having a particular one of the different management interfaces; and
the information handling system dispatching the management request to the particular information handling resource for conversion into the particular one of the different management interfaces.

10. The method of claim 9, further comprising returning a result of the management request to the user.

11. The method of claim 9, wherein the management portal is disposed within a demilitarized zone (DMZ) of a cloud system.

12. The method of claim 9, wherein the conversion into the particular one of the different management interfaces is carried out by an application programming interface (API) dispatcher located at a datacenter with the particular information handling resource.

13. An article of manufacture comprising a non-transitory, computer-readable medium having computer-executable code thereon that is executable by an information handling system for:
providing a management portal to a user via a network, wherein the management portal is configured to provide access to management interactions for a plurality of information handling resources having different management interfaces, and wherein the management portal is configured to provide access to such different management interfaces via a single interface exposed to the user;
receiving a management request from a user via the management portal for management of a particular information handling resource having a particular one of the different management interfaces; and
dispatching the management request to the particular information handling resource for conversion into the particular one of the different management interfaces.

14. The article of claim 13, wherein the single interface exposed to the user is a programmatic application programming interface (API).

15. The article of claim 13, wherein the conversion into the particular one of the different management interfaces is carried out by an application programming interface (API) dispatcher located at a datacenter with the particular information handling resource.

16. The article of claim 15, wherein the management portal is further configured to marshal the management request into a file for transmission to the datacenter.

17. The article of claim 16, wherein the API dispatcher is further configured to unmarshal the management request for conversion into the particular one of the different management interfaces.

18. The article of claim 13, wherein the management portal is disposed within a demilitarized zone (DMZ) of a cloud system.

19. The article of claim 13, wherein the different management interfaces include a plain text file, a script, a shell command, a remote procedure call, and a representational state transfer (REST) application programming interface (API).

20. The article of claim 13, wherein the information handling system comprises a hyper-converged infrastructure (HCI) system.
